(19) United States
(12) Patent Application Publication
(10) Pub. No.: US 2026/0057663 A1
(43) Pub. Date: Feb. 26, 2026

(54) SYSTEM AND METHOD FOR MODEL SELECTION WITH INTERACTING MULTIPLE MODEL TRACKER

(71) Applicant: Torc Robotics, Inc., Blacksburg, VA (US)

(72) Inventor: Bin Jia, Columbia, MD (US)

(21) Appl. No.: 18/815,788

(22) Filed: Aug. 26, 2024

(51) Int. Cl. G06V 10/70; G06T 7/20; G06V 10/764; G06V 20/56; G06V 20/58

(52) U.S. Cl. CPC G06V 10/87; G06T 7/20; G06V 10/764; G06V 20/58; G06V 20/588; G06T 2207/30256; G06T 2207/30261; G06V 2201/08

(57) ABSTRACT

A system for model selection with an interacting multiple model (IMM) tracker is provided. The system includes sensors associated with a vehicle that detect an object and object attributes, and includes a database that stores the object attributes, road attributes, and models capable of being assigned to the object as representative of motion type of the object. The system includes a processing device that limits the models to a shortened list based on selection of only models relevant to the object having the object attributes and the road attributes, assigns a model probability to each of the models representative of an estimation of a correct determination of relevance of each of the models, sorts the shortened model list from highest to lowest model probability, and assigns selected model(s) from the shortened model list having the highest model probability and/or a model probability greater than a predefined value to the object.

### TECHNICAL FIELD

The field of the disclosure relates to selection of models for objects surrounding an autonomous vehicle and, in particular, to a system for model selection with an interacting multiple model (IMM) tracker to ensure optimal and accurate object motion tracking around the autonomous vehicle.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Objects detected proximate to the vehicle can be of any type, e.g., other vehicles, pedestrians, bicycles, motorcycles, non-vehicles, or the like. These objects can be in a stationary position relative to the autonomous vehicle, or can move relative to the autonomous vehicle. Various models can be programmed into the autonomous vehicle as predictions of the motion of the objects proximate to the vehicle, allowing the autonomous vehicle to determine—based on the predicted motion of the objects—how to optimally maneuver along its planned route while safely avoiding collisions with the surrounding objects.

Interacted multiple model (IMM) tracker has been used for management of such models due to its ability to track surrounding objects. (See, e.g., Genovese, A. F., The Interacting Multiple Model Algorithm for Accurate State Estimation of Maneuvering Targets, Johns Hopkins APL Technical Digest, Vol. 22, No. 4 (2001)). However, due to the complex tracking scenarios for autonomous driving, a large number of models is typically used for each specific type of object and/or specific type of attributes of the object. Although a large amount of models exist, most of these models may not be useful to the final estimation or prediction of the object motion. As such, elevated processing requirements may be needed to determine which models may be relevant to the detected objects proximate to the autonomous vehicle, potentially increasing the reaction time of the vehicle. Improper or bad model selection can further lead to tracking performance degradation.

Accordingly, there exists a need for a system and a method of model selection with an IMM tracker for an autonomous vehicle that is capable of efficiently, accurately and dynamically selecting top candidate models based on context information associated with detected objects. These and other needs are met by the exemplary system for model selection discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for model selection with an interacting multiple model (IMM) tracker is provided. The system can be used to track all objects (e.g., vehicles, pedestrians, bicycles, non-vehicles, or any other physical items/obstructions) surrounding an autonomous vehicle using the IMM tracker. Multiple models are used in the IMM tracker, and the system adaptively maintains the model list for the tracker. The system ensures that the list of available models to choose from is sorted in a manner that the optimal applicable models are selected to a narrowed list and used for predicting motion of the objects proximate to the vehicle. In particular, the system is capable of efficiently, accurately and dynamically selecting top candidate models based on context information associated with detected objects. Such context information can include, e.g., road and/or lane information, object type, object attributes, weather conditions, road conditions, combinations thereof, or the like, in the IMM tracking loop. The system therefore prioritizes the motion type list for each object adaptively according to the context information, adaptively manages the active model list, and adaptively updates the motion type probability and transition matrix for the active model set. As such, accurate dynamic models are used that can substantially consistent with the actual motion of the objects proximate to the vehicle. The active model set and transition matrix which are required by the IMM model are maintained adaptively at each cycle of the tracker.

The system includes one or more sensors associated with a vehicle. The one or more sensors are configured to detect an object proximate to the vehicle and detect one or more object attributes of the object. The system includes a database configured to electronically store the one or more object attributes of the object detected by the one or more sensors, road and/or lane attributes associated with a path of the vehicle, and models capable of being assigned to the object as representative of motion of the object adjacent to the path. The system includes a processing device in communication with the one or more sensors and the database. The processing device is configured to execute instructions stored in a memory to perform operations that include executing a classifier unit to limit the models to a shortened model list based on selection of only the models relevant to the object having the one or more object attributes and the road and/or lane attributes associated with the path of the vehicle. The operations include assigning a model probability (e.g., a model probability value) to each of the models of the shortened model list representative of an estimation of a correct determination of relevance of each of the models of the shortened model list to the object having the one or more object attributes and the road and/or lane attributes associated with the path of the vehicle. The operations include sorting the shortened model list from highest to lowest model probability. The operations include assigning selected model(s) from the shortened model list having at least the highest model probability or a model probability greater than a predefined value to the object as representative of the motion of the object adjacent to the path. In some embodiments, the system can select a single model having the highest model probability or a model probability having the greatest value over the predefined value. In some embodiments, the system can select two or more models having the highest model probability or model probabilities greater than the predefined value.

The operations can include maintaining and updating the shortened model list and a transition matrix for the interacting multiple model (IMM) tracker to track all surrounding objects during motion of the vehicle. In some embodiments, the vehicle is can be autonomous vehicle or a semi-autonomous vehicle. The one or more object attributes can include at least one of the following non-limiting examples: a height, a length, a width, a velocity, a position relative to the vehicle, a class, or the like. The class can be one of a vehicle type, a non-vehicle physical object, a bicyclist, or a pedestrian. The road and/or lane attributes can include at least one of road topology, lane type, or lane curvature.

In some embodiments, the database can be configured to electronically store weather data representative of weather around or proximate to the vehicle. In such embodiments, the classifier unit can limit the models to the shortened model list based on selection of only the models relevant to the object having the one or more object attributes, the road and/or lane attributes associated with the path of the vehicle, and the weather data. In some embodiments, the models can include one or more of the following non-limiting examples: a constant velocity model (CV), a constant acceleration model (CA), a constant turn model (CT), a constant position model (CP), a constant turn rate and velocity model (CTRV), a constant turn rate and acceleration model (CTRA), a bicycle model, an extended bicycle model, or the like.

The selected model(s) is configured to generate a predicted motion of the object adjacent to the path. The operations can include monitoring the motion of the object adjacent to the path and assigning an observed motion to the object adjacent to the path. The operations can include comparing the predicted motion to the observed motion of the object to determine if the selected model(s) accurately reflects the motion of the object, and assigning the model probability based on a difference between the predicted motion and the observed motion obtained from the comparison. If the model probability is above a predetermined threshold, the operations comprise maintaining the selected model(s) as assigned to the object and representative of the motion of the object adjacent to the path. If the model probability is below a predetermined threshold, the operations can include dynamically updating the shortened model list based on the one or more object attributes and the road and/or lane attributes, assigning the confidence value to the updated shortened model list, sorting the updated shortened model list from highest to lowest model probability, and assigning a new model or models from the updated shortened model list having at least the highest model probability or the model probability greater than the predefined value to the object as representative of the motion of the object adjacent to the path. In some embodiments, the predetermined threshold can be about 50%. The classifier unit can operate with a context aware interacting multiple model (IMM) tracker.

In another aspect, an exemplary computer-implemented method for model selection with an interacting multiple model (IMM) tracker is provided. The method includes detecting an object proximate to a vehicle and one or more object attributes of the object with one or more sensors associated with the vehicle. The method includes electronically storing the one or more object attributes of the object detected by the one or more sensors, road and/or lane attributes associated with a path of the vehicle, and models capable of being assigned to the object as representative of motion of the object adjacent to the path in a database. The method includes executing instructions stored in a memory with a processing device in communication with the one or more sensors and the database to perform operations that include executing a classifier unit to limit the models to a shortened model list based on selection of only the models relevant to the object having the one or more object attributes and the road and/or lane attributes associated with the path of the vehicle. The operations include assigning a model probability to each of the models of the shortened model list representative of an estimation of a correct determination of relevance of each of the models of the shortened model list to the object having the one or more object attributes and the road and/or lane attributes associated with the path of the vehicle. The operations include sorting the shortened model list from highest to lowest model probability. The operations include assigning selected model(s) from the shortened model list having at least the highest model probability or a model probability greater than a predefined value to the object as representative of the motion of the object adjacent to the path.

The selected model(s) can be used by the IMM tracker to generate a predicted motion of the object adjacent to the path. The operations can include monitoring the motion of the object adjacent to the path and assigning an observed motion to the object adjacent to the path, comparing the predicted motion to the observed motion of the object to determine if the selected model(s) accurately reflects the motion of the object, and refining the model probability based on a difference between the predicted motion and the observed motion from the comparison. If the model probability given by the classifier unit is above a predetermined threshold, the operations can include maintaining the selected model(s) as assigned to the object and representative of the motion of the object adjacent to the path. If the model probability is below a predetermined threshold, the operations can include dynamically updating the shortened model list by removing obsolete model(s) and incorporating models given by the classifier unit with high model probability. In some embodiments, removing obsolete models and incorporating new models with the classifier unit can include, e.g., dynamically updating the shortened model list based on the one or more object attributes and the road and/or lane attributes, assigning the model probability to the updated shortened model list, sorting the updated shortened model list from highest to lowest model probability, and assigning a new model or new models from the updated shortened model list having at least the model probability score or the model probability greater than the predefined value to the object as representative of the motion of the object adjacent to the path.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck.

FIG. 2 is a block diagram of the autonomous truck shown in FIG. 1.

FIG. 3 is a block diagram of an example computing system.

FIG. 4 is a block diagram of an exemplary system for model selection.

FIG. 5 is a flowchart of a method for model selection.

FIG. 6 is a flowchart of a model selection performed by an exemplary system.

FIG. 7 is a flowchart of a context information collection unit executed by an exemplary system.

FIG. 8 is a flowchart of a motion model proposal unit executed by an exemplary system.

FIG. 9 is a flowchart of an active model set management unit executed by an exemplary system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for model selection discussed herein uses an interacted or interacting multiple model (IMM) tracker to efficiently select one or more models estimated to accurately track the motion of objects surrounding an autonomous vehicle. The system is capable of accurately selecting such models based on analysis of attributes of the object, the road/lane, and (in some instances) weather data. The system therefore analyzes context information dynamically when selecting top candidate models, resulting in more accurate model selection and applicability to the respective objects.

As discussed herein, the system incorporates both road/lane information and object attributes in the IMM tracking loop. The system prioritizes the motion type list for each object adaptively according to the context information. The system adaptively manages the active model list to narrow down and select the optimal models for the respective object. The system adaptively updates the motion type probability and transition matrix for the active model set. Such adaptive updating can be performed based on a comparison of the predicted and observed motion of the object and model probabilities assigned to the selected models. The system can therefore dynamically update the selected model list based on the predicted/observed motion comparison for the objects, and adjusts the models to achieve optimal model probabilities.

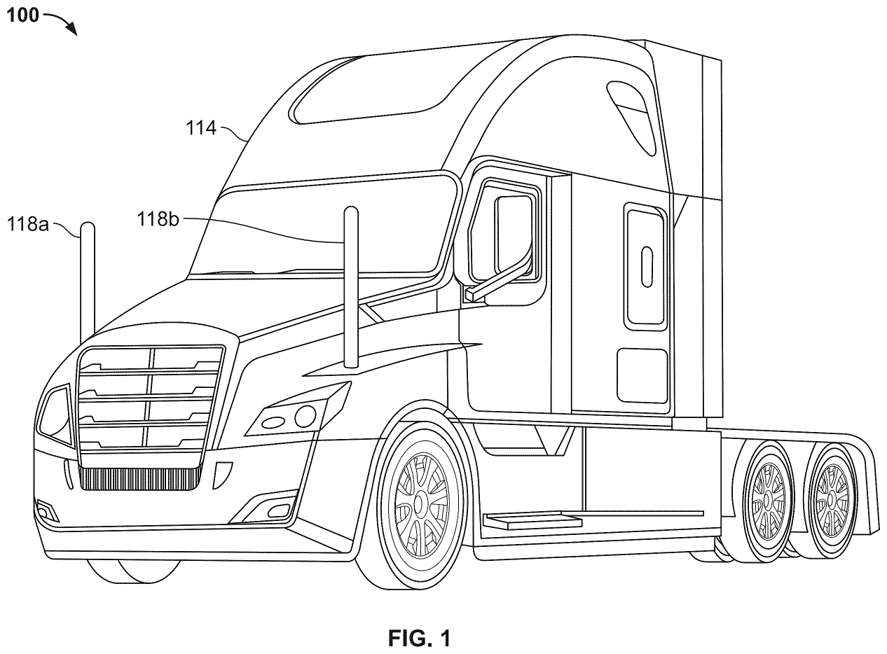

Various embodiments in the present disclosure are described with reference to FIGS. 1-9 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors. For example, the vehicle 100 can include one or more antenna 118a, 118b at or near the front of the vehicle 100 with sensors having a field-of-view at the front and/or sides of the vehicle 100.

Similar sensors can be used around the perimeter of the vehicle 100 to ensure full environmental coverage around the vehicle 100 is provided by the sensors. In some embodiments, the vehicle 100 can include, e.g., 5-6 LIDAR sensors, 8-10 cameras, combinations thereof, or the like. In some embodiments, the vehicle 100 can tow a trailer and the trailer can similarly include LIDAR sensors and/or cameras to provide field-of-view coverage around the perimeter of the vehicle 100 and the trailer. The environmental coverage by the sensors and/or cameras therefore provides data corresponding with the front, rear, sides and corners of the vehicle 100 and the trailer hauled by the vehicle 100.

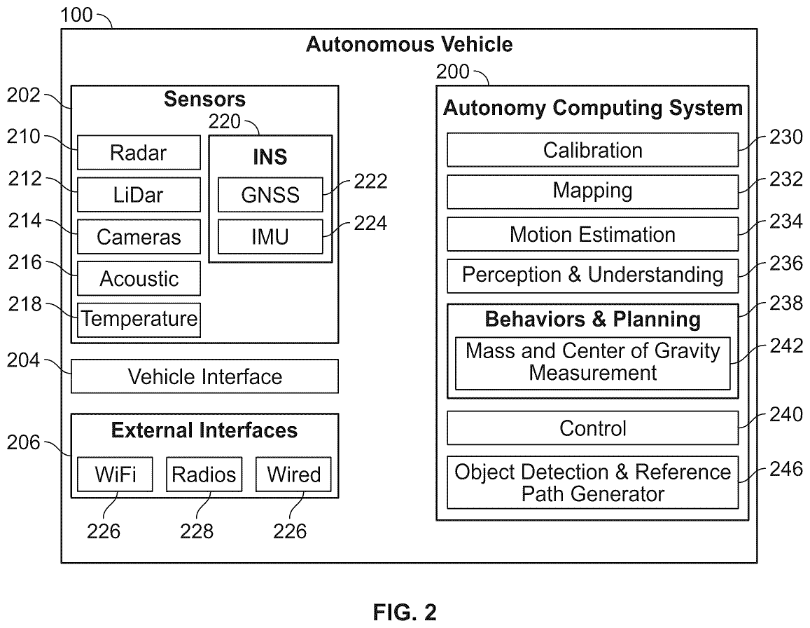

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 246 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

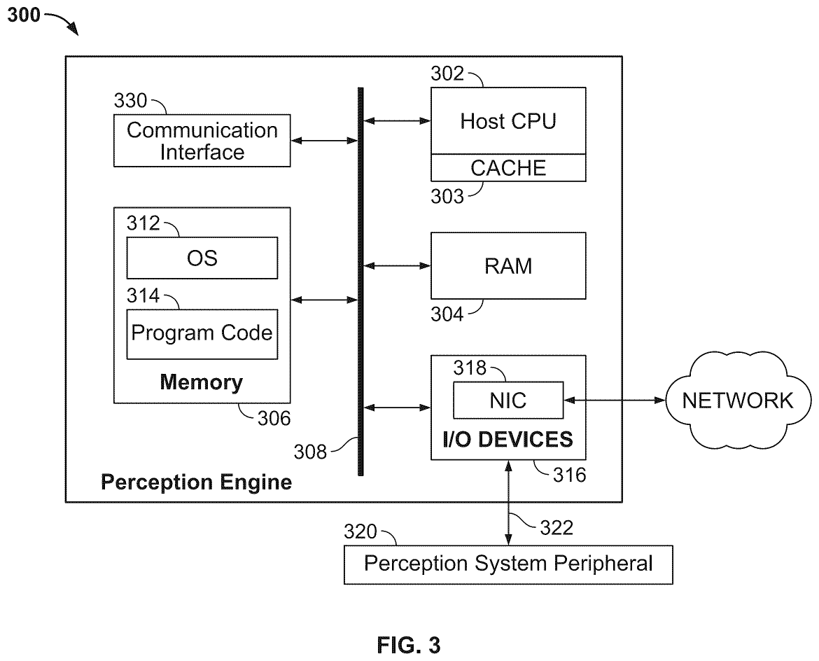

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

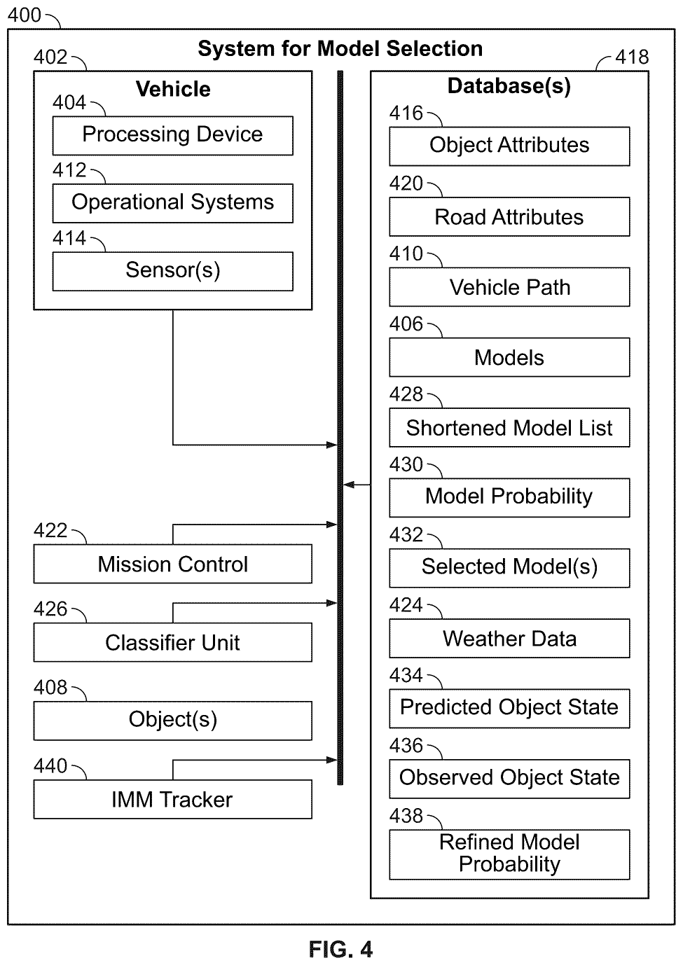

FIG. 4 is a block diagram of an exemplary system 400 for model selection. The system 400 generally includes one or more vehicles 402 (e.g., autonomous vehicle 100). Each vehicle 402 includes a processing device 404 (e.g., computing system 200, computing system 300, or the like) configured to receive and process data for selecting one or more models 406 estimated to accurately represent motion of one or more objects 408 disposed proximate to the vehicle 402 as the vehicle 402 moves along its path 410.

The objects 408 proximate to the vehicle 402 can be other vehicles or non-vehicle objects. For example, the objects 408 can be other vehicles traveling in adjacent lanes, in front or behind the vehicle 402 in the same lane, and/or other vehicles merging onto the road along which the vehicle 402 is traveling. The objects 408 can also include, e.g., pedestrians, bicycles, stationary objects, animals, or the like. The vehicle 402 includes various operational systems 412 (e.g., motion estimation 234, perception and understanding 236, behaviors and planning 238, control 240, object detection and reference path generator 246, or the like) that are used to control operation of the vehicle 402 along its path 410 based on the selected models 406 in order to safely guide the vehicle 402 along the path 410 while avoiding collision with the objects 408. One or more of the operations performed by the vehicle 402 can be communicated to and/or from mission control 422, which can be in communication with the vehicle 402 and the databases 418.

At least some of the data received by the processing device 404 can be data from one or more sensors 414 (e.g., sensors 202) associated with the vehicle 402. For example, the sensors 414 can detect the objects 408 around or proximate to the vehicle 402 as the vehicle 402 travels along its route or path 410 (or while the vehicle 402 is stationary at a point along its path 410). In addition to detecting the existence of the objects 408, the sensors 414 are capable of determining various attributes 416 of the detected objects 408. In some embodiments, the object attributes 416 can be, e.g., an object height, an object length, an object width, an object velocity, an object position/distance relative to the vehicle 402, an object class, or the like. The object class can include, e.g., a vehicle type, a non-vehicle physical object, a bicyclist, a pedestrian, an animal, or the like.

The vehicle 402 can include or can be in communication with one or more databases 418 (e.g., memory 306) configured to receive and electronically store data. In some embodiments, the database 418 can be stored on the vehicle 402 itself. In some embodiments, the database 418 can be stored externally from the vehicle 402 and the vehicle 402 can be in communication with the external database 418 for receiving and/or transmitting data associated with the system 400. The database 418 can be used to receive and store the object attributes 416 detected by the sensors 414. The database 418 can also store lane and/or road attributes 420 associated with the path 410 along which the vehicle 402 is traveling. In some embodiments, the road attributes 420 can be conditions of the road determined from sources other than the sensors 414, e.g., the curvature of the road through a global positioning system (GPS), the elevational change based on topographical data, the speed limit, lane type, or the like. In some embodiments, the road attributes 420 can be conditions of the road determined from the sensors 414, e.g., lane closures, lane type, lane number, lane curvature, lane color, potholes in the road, or the like.

The database 418 stores various models 406, each of which is representative of estimations associated with object 408 motion. The models 406 depend on the object and/or road attributes 416, 420. In some embodiments, weather conditions or data 424 can also affect the type of model 406 chosen for estimation of the object 408 motion. The weather data 424 can include current weather conditions and/or predicted weather conditions along the path 410. As non-limiting examples, the models 406 can include, e.g., a constant velocity model (CV), a constant acceleration model (CA), a constant turn model (CT), a constant position model (CP), a constant turn rate and velocity model (CTRV), a constant turn rate and acceleration model (CTRA), a bicycle model, an extended bicycle model, or the like. A variety of known prediction models can be used by the system, such as those discussed in, e.g., Li, X. R. et al., Survey of Maneuvering Target Tracking. Part I. Dynamic models., IEEE Transactions on Aerospace and Electronic Systems, Vol. 39, No. 4, 1333-1364 (2003); and Schwab, A. L. et al., Some Recent Developments in Bicycle Dynamics, Proceedings of the 12^{th} World Congress in Mechanism and Machine Science, pp. 1-6, Moscow, Russia, Russian Academy of Sciences (2007)). Based on the attributes (e.g., context information), the system 400 estimates which models 406 most accurately predict the motion of the object 408 adjacent to the path 410 of the vehicle 402, allowing the vehicle 402 to adjust its motion as needed along the path 410 to ensure safe passage.

In particular, the processing device 404 of the vehicle 402 and/or mission control 422 can execute a classifier unit 426 to limit the models 406 to a shortened model list 428 based on a selection of only the models 406 the system 400 considers to be relevant to the object 408 having the one or more object attributes 416 and the road attributes 420 (and/or weather data 424) associated with the path 410 of the vehicle 402. The relevance of the models 406 can be determined based on these attributes/data and which models 406 may most accurately estimate the motion of the object 408 adjacent to the vehicle 402. In some embodiments, the classifier unit 426 can be part of the vehicle 402, part of mission control 422, or both. In some embodiments, the classifier unit 426 can operate as a context aware interacting multiple model (IMM) tracker.

The processing device 404 can assign a model probability 430 (e.g., a numerical probability value or range) to each of the models 406 of the shortened model list 428. The model probability 430 can be representative of an estimation of a correct determination of relevance of each of the models 406 of the list 428 to the object 408 having the attributes. In particular, the model probability 430 ranks each of the models 406 as having a higher or lower likelihood of accurately estimating the object 408 motion based on the input attributes. The shortened model list 428 is subsequently sorted from highest to lowest model probability 430, ensuring that models 406 with the highest likelihood of accurate object 408 motion estimation are grouped together. The processing device 404 can then assign one or more selected models 432 from the list 428 to the object 408. The selected models 432 can have at least the highest model probability 430, a model probability 430 greater than a predefined value (e.g., a threshold value), or both. The selected models 432 are then used to estimate the object 408 motion and how the operational systems 412 of the vehicle 402 should control the vehicle 402.

The system 400 dynamically and adaptively maintains and updates the shortened model list 428 and a transition matrix for the IMM tracker to track all surrounding objects 408 during motion of the vehicle 402 along the path 410. In particular, the system 400 can continuously (or substantially continuously) monitor the objects 408 and determine if new objects 408 are detected and/or if the previously selected models 432 accurately estimate the motion of the previously detected objects 408. For example, the system 400 can generate prediction object state 434 (e.g., a predicted object state, for example, position, or position and velocity) of the objects 408 based on the selected models 432. After the models 432 are assigned to the object 408, motion of the object 408 is tracked along the path with by a IMM tracker 440, e.g., the sensors 414, and an observed object state 436 (e.g., observed object position, or position and velocity as well as size information) is used by the IMM tracker 440 to update the object 408 state. The observed object state 436 can be the measured by the sensors 414 with random noise from the sensors 414.

The processing device 404 can compare the prediction object state 434 to the observed object state 436 to determine if the selected models 432 accurately reflect or match the actual motion of the object 408. A variety of models 432 can be used, including but not limited to those discussed in, e.g., Li, X. R. et al., Survey of Maneuvering Target Tracking. Part V. Multiple-Model Methods., IEEE Transactions on Aerospace and Electronic Systems, Vol. 41, No. 4, 1255-1321 (2005). This allows the system 400 to double-check the accuracy of the selected models 432 to determine if adjustment of the assigned/selected models 432 is needed to more accurately predict and estimate the motion of the object 408 moving forward. Based on a difference between the prediction object state 434 and the observed object state 436, a model probability 430 can be generated and assigned to each selected model 432. If the model probability 430 is above a predetermined threshold (e.g., above 50%, or the like), the system 400 can maintain the selected models 432 as assigned to the object 408.

However, if the model probability 430 is below the predetermined threshold, the system 400 can dynamically update the shortened model list 428 based on the previously and/or newly detected object attributes 416, the previously and/or newly detected road attributes 420, and/or the weather data 424. The IMM tracker 440 can also be used to reassess the object attributes 416, the previously and/or newly detected road attributes 420, and/or the weather data 414, to refine the model probabilities 430 in the form of refined model probabilities 438. After refinement, the models 406 of the list 428 can then be assigned new refined model probabilities 438 for sorting, and the system 400 selects new models 432 based on their refined model probabilities 438 for assignment to the object 408. In some instances, the newly selected models 432 can be the same as the previously selected models 432. In some instances, one or more of the newly selected models 432 can be different from the previously selected models 432. The system 400 can dynamically execute the comparison function to determine model probabilities 430 for the predicted vs. observed object state 434, 436 to adapt the selected models 432, ensuring accurate and dynamic model 406 selection. The sorting and narrowing of models 406 allows for a faster processing time when selecting models 406, and a more accurate model 406 selection based on context information, ensuring safer operation of the vehicle 402. For example, the system 400 can operate 24 hrs/day while processing an extensive number of models, with the optimized selection process reducing processing time and complexity.

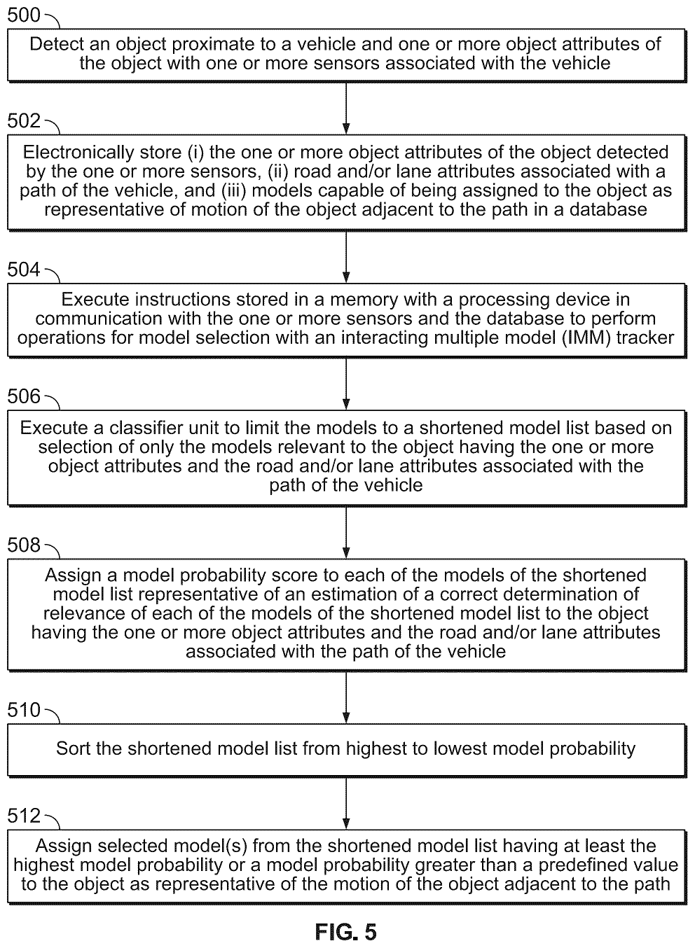

FIG. 5 is a flowchart of a method of model selection by the exemplary system 400 discussed herein. At 500, an object proximate to a vehicle and one or more object attributes of the object are detected with one or more sensors associated with the vehicle. At 502, the one or more object attributes of the object detected by the one or more sensors, road and/or lane attributes associated with a path of the vehicle, and models capable of being assigned to the object as representative of motion of the object adjacent to the path are electronically stored in a database. At 504, instructions stored in a memory are executed with a processing device in communication with the one or more sensors and the database to perform operations for model selection with an interacting multiple model (IMM) tracker.

At 506, a classifier unit is executed to limit the models to a shortened model list based on selection of only the models relevant to the object having the one or more object attributes and the road and/or lane attributes associated with the path of the vehicle. At 508, a model probability is generated and assigned to each of the models of the shortened model list representative of an estimation of a correct determination of relevance of each of the models of the shortened model list to the object having the one or more object attributes and the road and/or lane attributes associated with the path of the vehicle. At 510, the shortened model list is sorted from highest to lowest model probability. At 512, selected model(s) are assigned from the shortened model list having at least the highest model probability or a model probability greater than a predefined value to the object as representative of the motion of the object adjacent to the path. The process is dynamically adapted based on differences between the predicted and observed object state to determine if new or different models should be assigned to the object with higher accuracy of estimating the object's motion. The process therefore yields faster and more accurate object motion estimation.

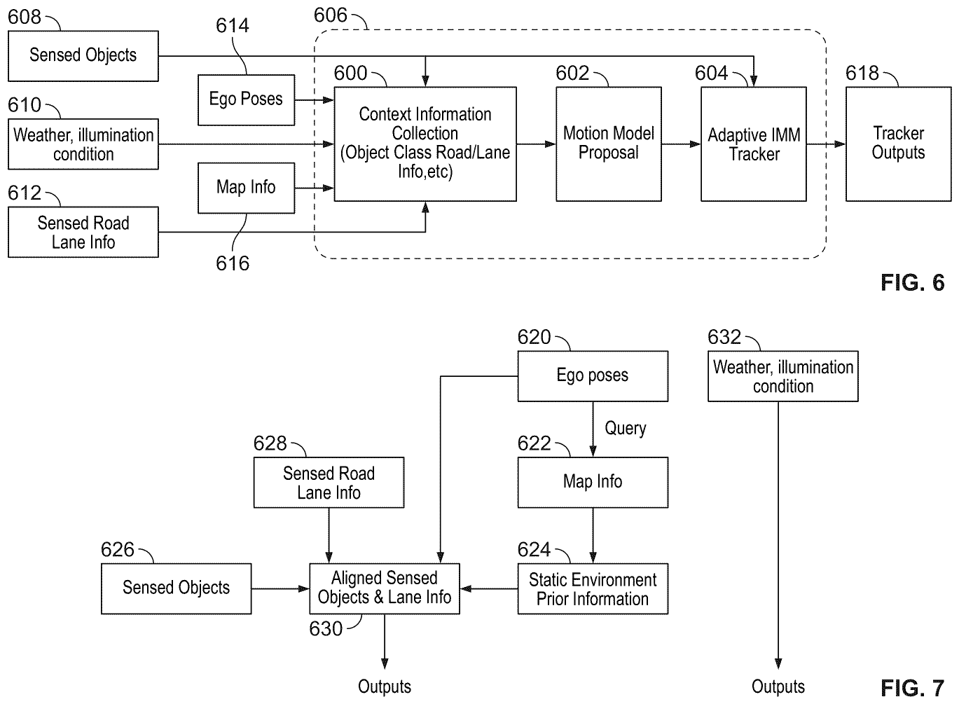

FIG. 6 is a flowchart and block diagram of a model selection performed by the exemplary system 400. The system generally includes a context information collection unit 600, a motion model proposal unit 602, and an adaptive IMM tracker unit 604, each of which can be executed by the processing device of the autonomous vehicle. The units 600, 602, 604 can be collectively referred to as a context aware IMM tracker 606. The context information collection unit 600 can receive as input and collects information about the tracker context, such as data relating to the sensed objects 608 (received from object detector outputs), weather and/or illumination conditions 610, lane and/or road information 612, or the like. The tracker therefore detects and senses various objects proximate to the vehicle as it moves along its path.

Some of the information about the objects can include, e.g., object type, object size, object weight, object velocity, object acceleration, combinations thereof, or the like. The object type can include the class of vehicle, e.g., truck, car, motorcycle, police car, school bus, or the like. The unit 600 can also receive as input information regarding the autonomous vehicle 614 itself, and map information 616 regarding the planned path of the vehicle 614 (and lane information for other moving objects). Some path/lane attributes can include road information, such as the type of road on which the vehicle and/or object is located, e.g., ramp to highway, straight road, curved road, or the like. The road information can be data acquired by sensors as the vehicle travels along its path, road information available from other databases (e.g., GPS), and/or road conditions previously acquired by the vehicle or other vehicles traveling along the same road. Environmental context information (e.g., road attributes, weather attributes, or the like) is therefore also included in the input data to ensure an accurate consideration of models for selection.

Based on this input information, the motion model proposal unit 602 can select candidate models for each specific object. Different models are used for different types of objects based on proper applicability, e.g., based on predicted behavior for certain types of other vehicle classes—truck, trailer, bus, car, motorcycle, or the like. The output of the unit 602 can include the selected motion models, the prior model probability, and the corresponding state switch matrix. The tracker unit 604 can receive as input the state switch matrix and fuses the prior model probability as well as the model probability calculated by multiple models to update the IMM tracker output 618. The output 618 can include the final selected models to be applied as accurate estimations of the object motion. If the models selected are inaccurate, safety issues for operation of the vehicle can arise. As such, the tracker optimizes the accuracy of selection of appropriate models for each of the objects proximate to the vehicle.

The models to be selected are taken from an automatically limited list to reduce processing time. The system therefore does not need to run through all models to determine which models to apply to the object, ensuring efficiency of processing. Such model selection assists the tracker to track object accurately. For example, if the detected object is a pedestrian instead of a traffic light or other vehicle, the tracker can select different model to handle the dynamics of that object. The assigned model and narrowed model list can be maintained adaptively and dynamically, with the system updating such models based on determination of performance of the model relative to observed object state. The optimal models are therefore selected for monitoring the object motion over time and for controlling operation of the autonomous vehicle.

FIG. 7 is a flowchart and block diagram of a context information collection unit 600 executed by the exemplary system 400. The unit 600 can perform as an information aggregator which collects environment and associated information from different sources. At 620, the vehicle can query the information request, which can include map information 622 and status environment prior information 624. Sensed object 626 data and sensed road lane information 628 (along with the previously queried information) can be transmitted to an aligned sensed object and lade info block 630. Weather and/or illumination conditions 632 can also be output for consideration.

Information from different sources is therefore aligned and synchronized for consideration for model selection. Such alignment and synchronization occurs because the data can be collected at different times as the object is moving relative to the vehicle. However, the system associates and aligns the information into a usable format to assist with the model selection determination process. The system not only collects the data, but determines the correct association with the respective object. Correct association, as discussed herein, refers to whether the object is correctly associated with the lane provided. The lane perception provided by sensor or lane information from the map is not necessarily aligned with the object. The object should correctly associate with specific lane number, lane type, lane speed, or the like. For example, if there are five lanes (named lane 1, 2, 3, 4, 5), and there are 3 objects (object 7, 8, 9), the correct association means can be 2-7, 3-8, 4-9. Incorrect association are other combinations, such as 2-9. Such context information allows for the system to accurately consider which models would be the most accurate for predicting motion of the respective detected objects. The context information is therefore used to prioritize the models before model selection occurs.

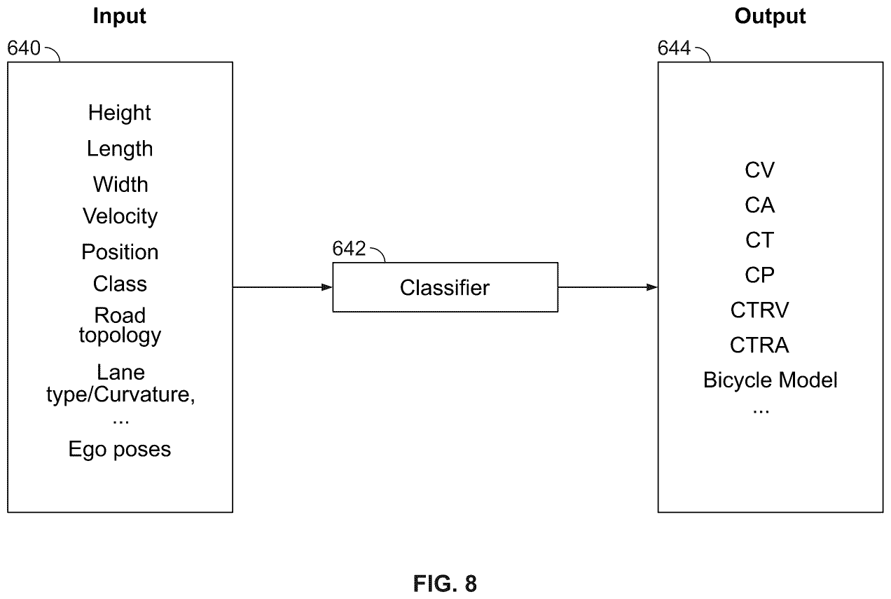

FIG. 8 a flowchart and block diagram of a motion model proposal unit 602 executed by the exemplary system 400. Based on the input 640 of context information into the classifier 642, the classifier 642 selects models 644 that are considered relevant to the detected objects. The models 644 are a narrowed list of models selected from a larger, extensive list. This narrowed list ensures that the processing time for determining which model(s) to apply to the object will be more efficient than reviewing all models. The input 640 can include, but is not limited to, e.g., height, length, width, velocity, position, class, road topology, lane type, lane curvature, autonomous vehicle characteristics, or the like.

As a non-limiting example, the models 644 selected by the classifier 642 include, e.g., a constant velocity model (CV), a constant acceleration model (CA), a constant turn model (CT), a constant position model (CP), a constant turn rate and velocity model (CTRV), a constant turn rate and acceleration model (CTRA), a bicycle model, and an extended bicycle model. In order to select promising and accurate models, a comprehensive collection of motion models with consideration of different road/lane type, weather, vehicle type, pedestrian, and traffic rules is considered.

Given the input information about object detection outputs, such as class, object size, position, velocity, orientation, ego velocity, and road topology and lane information, both learned classifiers and rule based classifiers can be used to determine the motion model types. For the learned classifiers, both deep learning and conventional machine learning methods (such as, e.g., Light Gradient Boosting Machine) can be used. In some embodiments, the problem can be treated as a multi-variate time series classification problem. The information at different time instants can be collected and then used for the classification problem. For the rule based method, the process can be flexible.

For example, for an object on a straight lane, CV, CA, CP may be a better choice than CT, CTRV, or CTRA. For an object on a curved road, CT, CTRV, CTRA may be a better choice. Alternatively, for a cab-trailer object, an extended bicycle model can be a better choice than simple CV, CA models. For static objects, the CP model may be a better model to include in the active model set. Such model selection can be performed based on training of the classifier using previous data, including models which were accurately used to predict specific objects having the same or similar attributes. The model selection can occur at different places, and the classifier can output the model probabilities for each model. For example, first, the system can select the model based on the classifier output (the initial model probability). Next, the IMM tracker can update or refine the model probability with observations dynamically. The process therefore involves the classifier outputting initial model probabilities for all models, and a threshold is used to select possible models. This selection is output to the IMM tracker, which maintains the model probability of all models in the active model set. This operation occurs recursively.

As the output of the classifier, each motion type is assigned a probability or model probability. Given a specific hyper-parameter (threshold), the model with probability higher than the threshold (and/or the highest probability) can be considered as the initial list of selected models. For a scenario where multiple objects are involved, each object will have their respective unique motion type list. The final motion type list only considers representative motion types.

Due to the requirement of IMM, the transition matrix between different motion models needs to be initialized. To this end, the data driven method can be used to calculate the confusion matrix offline as the transition matrix. For the selected models, the system extracts the necessary sub-matrix from the origin matrix, which is loaded when the system is started. The steps of this operation can include the following. Given the validation and test dataset, the system calculates the confusion matrix on the motion type classification problem offline. The whole confusion matrix is loaded into the system when the IMM tracker is started. Based on active model set, the system finds corresponding row indices and column indices for the specific motion type lists. The system assigns the correct values for the transition matrix.

Machine learning can be used to optimize the accuracy of model selection over time. The system therefore assigns the model probability (e.g., probability) to each of the models based on how true and correctly each model can predict motion type of the object based on the context information. The order of models is sorted such that the highest probability models are selected in the transition matrix. For example, the total model count can be ten models, and only two models are selected as being applicable to the model in the specific context conditions. The narrowed sub-matrix of models can be loaded into the system for IMM tracker use to perform calculations for object motion prediction. The system can adaptively and dynamically update in real-time (or substantially real-time) the models being selected and used for the object motion prediction based on a comparison of the predicted and observed object state.

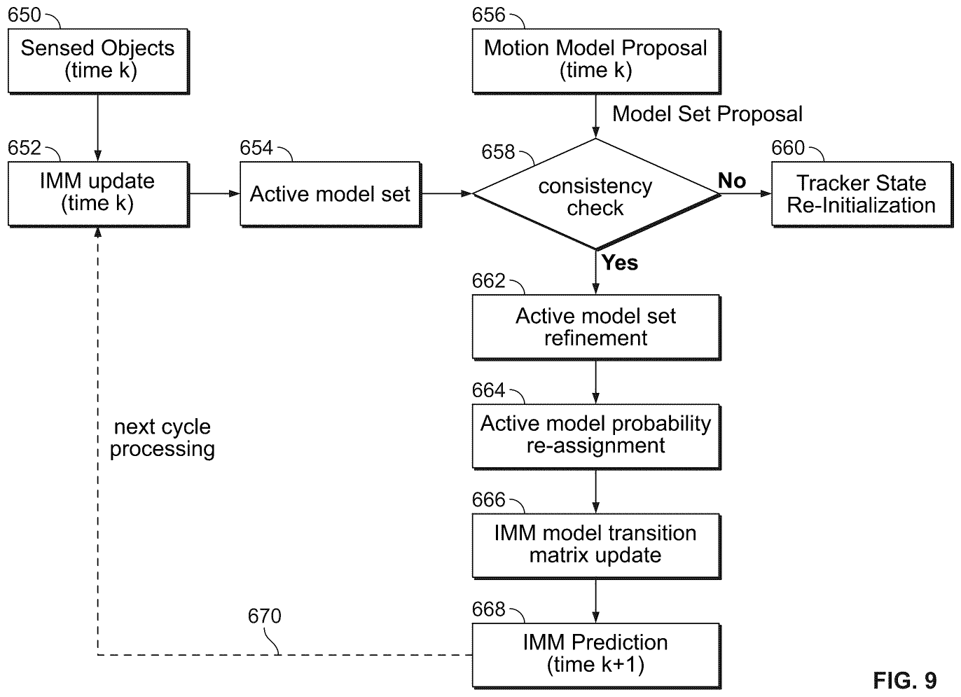

FIG. 9 is a flowchart and block diagram of an active model set management unit executed by the exemplary system 400. For example, with more information collected with time, the active model set used in the IMM tracker can be trimmed or expanded. The flowchart of FIG. 9 illustrates a simple mechanism to manage the active model set. At 650, when the detected objects at time k are available, the IMM update at 652 is performed first, and a model list at 654 is generated. At the same time, at 656, the motion model proposal unit can propose a new model set, which is compared with current active model set at 658. The consistency check is therefore performed at 658.

If the consistency check fails, at 660, the tracker state is re-initialized based on the new motion model proposal and observations. Otherwise, if the consistency check passes, at 662, the active model set is refined. First, obsolete models are removed when the model probability is lower than the removal threshold ϵᵣ. In addition, new models from the motion model proposal unit for which the model probability is beyond the adding threshold ϵα are added. After the refinement of the active model set, at 664, the model probability is re-assigned. Using the same methods mentioned above, the IMM model transition matrix can be updated at 666. Finally, the next filter cycle 670 (IMM prediction and IMM update 668) can be performed.

With specific reference to the model probability re-assignment, it can be assumed the model set at time k is Ωₖ. With the new detections given by the detector, the motion model proposal unit proposes a new set Ωₖ₊₁ at time k +1. If Ωk and Ωₖ₊₁ are significantly different, then the filter the filter needs to be reset. A numerical value can be used to determine the significant difference, such as the intersection over union of two sets of models. [If there is no significant change, the following procedure can be used to update the model set on the fly.

For convenience, it can be assumed that the model weights of the new model set are {m₁, . . . , mₙ}. The active model set includes p models with model weights m₁, . . . , mₚ. In addition, it can be assumed that a new model with weight \tilde{m}_{q} needs to be added to the active model set. The procedure involves the following. The model weights in the active model set are normalized as m̅₁, . . . , m̅ₚ. The model weights for the new active model set, i.e., M₁, . . . , Mₚ, M_{q}, are calculated. The new weights are given by {(1−β)·m̅₁, . . . , (1−β)·m̅ₚ, β}, where

$$β = \frac{{\tilde{m}}_{q}}{{\overline{m}}_{1} + … + {\overline{m}}_{p} + {\tilde{m}}_{q}} .$$

The new active model set can subsequently be used. The state interaction to define the transition probability from model i to model j can also be used, as discussed in, e.g., Genovese, A. F., The Interacting Multiple Model Algorithm for Accurate State Estimation of Maneuvering Targets, Johns Hopkins APL Technical Digest, Vol. 22, No. 4 (2001).

The process of adapting and updating the model list is therefore performed from the current time to the next or subsequent time, and can be recursively running in the system. The active model set can change depending on the context information received by the system. As such, the model set can be continuously updated in real-time. The system can generate a prediction based on the motion model to predict the state of the object from the current time to the next time. Updates to the model set are performed using the current context information, the consistency check, and ensuring alignment between the current state and the predicted state. The system determines if the suggested model was accurate in its prediction based on the observed state of the object. If the model result is accurate (within a predetermined threshold range), the same model can be used. If the model was inaccurate, a new model set can be assigned or refined using the IMM tracker. The model list can therefore be dynamically updated and refined to ensure optimal operation of the vehicle. In some embodiments, rather than running continuously, the system can refine the model set every 30 sections, for example. As the vehicle travels along the road and different objects are detected, for each object, the system performs the model selection to ensure proper and safe control of the vehicle.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for model selection with an interacting multiple model (IMM) tracker, the system comprising:
one or more sensors associated with a vehicle, the one or more sensors configured to detect an object proximate to the vehicle and detect one or more object attributes of the object;
a database configured to electronically store (i) the one or more object attributes of the object detected by the one or more sensors, (ii) road and/or lane attributes associated with a path of the vehicle, and (iii) models capable of being assigned to the object as representative of a motion type of the object adjacent to the path; and
a processing device in communication with the one or more sensors and the database, wherein the processing device is configured to execute instructions stored in a memory to perform operations comprising:
executing a classifier unit to limit the models to a shortened model list based on selection of only the models relevant to the object having the one or more object attributes and the road and/or lane attributes associated with the path of the vehicle;
assigning a model probability to each of the models of the shortened model list representative of an estimation of a correct determination of relevance of each of the models of the shortened model list to the object having the one or more object attributes and the road and/or lane attributes associated with the path of the vehicle;
sorting the shortened model list from highest to lowest model probability; and
assigning selected model(s) from the shortened model list having at least the highest model probability or a model probability greater than a predefined value to the object as representative of the motion type of the object adjacent to the path.

2. The system of claim 1, wherein the operations comprise maintaining and updating the shortened model list and a transition matrix for the interacting multiple model (IMM) tracker to track all surrounding objects during motion of the vehicle.

3. The system of claim 1, wherein the vehicle is an autonomous vehicle.

4. The system of claim 1, wherein the one or more object attributes include at least one of a height, a length, a width, a velocity, a position relative to the vehicle, or a class.

5. The system of claim 4, wherein the class is one of a vehicle type, a non-vehicle physical object, a bicyclist, or a pedestrian.

6. The system of claim 1, wherein the road and/or lane attributes include at least one of road topology, lane type, or lane curvature.

7. The system of claim 1, wherein the database is configured to electronically store weather data representative of weather around the vehicle.

8. The system of claim 7, wherein the classifier unit limits the models to the shortened model list based on selection of only the models relevant to the object having the one or more object attributes, the road and/or lane attributes associated with the path of the vehicle, and the weather data.

9. The system of claim 1, wherein the models include a constant velocity model (CV), a constant acceleration model (CA), a constant turn model (CT), a constant position model (CP), a constant turn rate and velocity model (CTRV), a constant turn rate and acceleration model (CTRA), a bicycle model, and an extended bicycle model.

10. The system of claim 1, wherein the selected model(s) is configured to generate a predicted motion of the object adjacent to the path.

11. The system of claim 10, wherein the operations comprise monitoring the motion of the object adjacent to the path and assigning an observed motion to the object adjacent to the path.

12. The system of claim 11, wherein the operations comprise comparing the predicted motion state to the observed motion state of the object to determine if the selected model(s) accurately reflects the motion state of the object, and refining the model probability based on a difference between the predicted motion state and the observed motion state obtained from the comparison.

13. The system of claim 12, wherein if the refined model probability is above a predetermined threshold, the operations comprise maintaining the selected model(s) as assigned to the object and representative of the motion type of the object adjacent to the path.

14. The system of claim 12, wherein if the model probability is below a predetermined threshold, the operations comprise dynamically updating the shortened model list based on the one or more object attributes and the road and/or lane attributes, refining the model probability to the updated shortened model list, sorting the updated shortened model list from highest to lowest model probability, and assigning a new model or models from the updated shortened model list having at least the highest model probability or the model probability greater than the predefined value to the object as representative of the motion type of the object adjacent to the path.

15. The system of claim 14, wherein the predetermined threshold is 50%.

16. The system of claim 1, wherein the classifier unit operates as a context aware interacting multiple model (IMM) tracker.

17. A computer-implemented method for model selection with an interacting multiple model (IMM) tracker, comprising:
detecting an object proximate to a vehicle and one or more object attributes of the object with one or more sensors associated with the vehicle;
electronically storing (i) the one or more object attributes of the object detected by the one or more sensors, (ii) road and/or lane attributes associated with a path of the vehicle, and (iii) models capable of being assigned to the object as representative of a motion type of the object adjacent to the path in a database; and
executing instructions stored in a memory with a processing device in communication with the one or more sensors and the database to perform operations comprising:
executing a classifier unit to limit the models to a shortened model list based on selection of only the models relevant to the object having the one or more object attributes and the road and/or lane attributes associated with the path of the vehicle;
assigning a model probability to each of the models of the shortened model list representative of an estimation of a correct determination of relevance of each of the models of the shortened model list to the object having the one or more object attributes and the road and/or lane attributes associated with the path of the vehicle;
sorting the shortened model list from highest to lowest model probability; and
assigning selected model(s) from the shortened model list having at least the highest model probability or a model probability greater than a predefined value to the object as representative of the motion type of the object adjacent to the path.

18. The computer-implemented method of claim 17, wherein the selected model(s) is configured to generate a predicted motion of the object adjacent to the path, and wherein the operations comprise (i) monitoring the motion of the object adjacent to the path and assigning an observed motion to the object adjacent to the path, (ii) comparing the predicted motion to the observed motion of the object to determine if the selected model(s) accurately reflects the motion of the object, and (iii) refining the model probability based on a difference between the predicted motion state and the observed motion state from the comparison.

19. The computer-implemented method of claim 18, wherein if the model probability is above a predetermined threshold, the operations comprise maintaining the selected model(s) as assigned to the object and representative of the motion type of the object adjacent to the path.

20. The computer-implemented method of claim 18, wherein if the model probability is below a predetermined threshold, the operations comprise dynamically updating the shortened model list based on the one or more object attributes and the road and/or lane attributes, assigning the model probability to the updated shortened model list, sorting the updated shortened model list from highest to lowest model probability, and assigning a new model or new models from the updated shortened model list having at least the highest model probability or the model probability greater than the predefined value to the object as representative of the motion type of the object adjacent to the path.
